(19) United States
(12) Patent Application Publication
(10) Pub. No.: US 2024/0038003 A1
(43) Pub. Date: Feb. 1, 2024

(54) IN-VEHICLE COMMUNICATION SYSTEM, IN-VEHICLE DEVICE, AND INTERFACE DEVICE

(71) Applicant: DENSO CORPORATION, Kariya-city (JP)

(72) Inventors: Toshiro ISHIHARA, Kariya-city (JP); Keisuke IKUSHIMA, Kariya-city (JP)

(21) Appl. No.: 18/483,508

(22) Filed: Oct. 9, 2023

Related U.S. Application Data
(63) Continuation of application No. PCT/JP22/11935, filed on Mar. 16, 2022.

(30) Foreign Application Priority Data
Apr. 14, 2021 (JP) 2021-068433

(51) Int. Cl. G07C 5/08; B60R 16/023; B60R 16/033; B60Q 1/52

(52) U.S. Cl. CPC G07C 5/0825; B60R 16/023; B60R 16/033; B60Q 1/52

(57) ABSTRACT

An in-vehicle device having a function of detecting an anomaly in an in-vehicle system and an interface device having an LED for notifying an occupant of a vehicle of an anomaly state are connected via a communication path for transmitting an alternating current signal. The cathode of the LED is connected to the vehicle body ground, and the anode is connected to the communication line of the communication path via the inductor. When the in-vehicle device detects an anomaly in the in-vehicle system, the in-vehicle device notifies the occupant of the vehicle of the anomaly by applying a direct current drive signal to the communication line to drive the LED.

### CROSS REFERENCE TO RELATED APPLICATION

The present application is a continuation application of International Patent Application No. PCT/JP2022/011935 filed on Mar. 16, 2022, which designated the U.S. and claims the benefit of priority from Japanese Patent Application No. 2021-068433 filed on Apr. 14, 2021. The entire disclosures of all of the above applications are incorporated herein by reference.

### TECHNICAL FIELD

The present disclosure relates to a system for performing digital communication between a plurality of devices mounted on a vehicle, and devices used in the system.

### BACKGROUND

For example, there are in-vehicle digital communication systems, such as A²B (i.e., Automotive Audio Bus) and INICnet (Intelligent Network Interface Controller networking, registered trademark), which are designed to transmit audio signals. Such digital communication can be applied, for example, to transmit audio signals from a microphone or speaker used for voice communication when an emergency notification device executes an emergency notification to an information center or the like.

Here, A²B is described in materials provided by Analog Devices Inc., for example, and INICnet is described in materials provided by, for example, Microchip Technology Inc. In addition, no prior art documents to be presented in particular were found.

### SUMMARY

According to an example, an in-vehicle device having a function of detecting an anomaly in an in-vehicle system and an interface device having an LED for notifying an occupant of a vehicle of an anomaly state are connected via a communication path for transmitting an alternating current signal. The cathode of the LED is connected to the vehicle body ground, and the anode is connected to the communication line of the communication path via the inductor. When the in-vehicle device detects an anomaly in the in-vehicle system, the in-vehicle device notifies the occupant of the vehicle of the anomaly by applying a direct current drive signal to the communication line to drive the LED.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a functional block diagram showing the configuration of an in-vehicle communication system according to a first embodiment;

FIG. 2 is a functional block diagram showing the configuration of an in-vehicle communication system according to a second embodiment;

FIG. 3 is a functional block diagram showing the configuration of an in-vehicle communication system according to a third embodiment;

FIG. 4 is a functional block diagram showing the configuration of an in-vehicle communication system according to a fourth embodiment;

FIG. 5 is a functional block diagram showing the configuration of an in-vehicle communication system according to a fifth embodiment;

FIG. 6 is a functional block diagram showing the configuration of an in-vehicle communication system according to a sixth embodiment;

FIG. 7 is a functional block diagram showing the configuration of an in-vehicle communication system according to a seventh embodiment;

FIG. 8 is a functional block diagram showing the configuration of an in-vehicle communication system according to an eighth embodiment;

FIG. 9 is a functional block diagram showing the configuration of an in-vehicle communication system according to a ninth embodiment; and

FIG. 10 is a functional block diagram showing the configuration of an in-vehicle communication system according to a tenth embodiment.

### DETAILED DESCRIPTION

Here, communication between the emergency notification device and an interface device equipped with, for example, an emergency notification microphone and speaker, a notification activation switch, and an LED for notifying the user of the occurrence of an anomaly in an emergency notification system and the like is changed to a digital type communication. Then, when the digital communication cannot be established immediately after the emergency notification device is activated, or when communication becomes unavailable due to an anomaly occurring in the digital communication unit, the interface device may not notify the user of the system anomaly.

The present embodiments have been made in view of the above circumstances, and an object of the present embodiments is to provide a communication system that can reliably notify an occupant of a vehicle that an anomaly has occurred in a system including an in-vehicle device even when communication is not available, an in-vehicle device and an interface device used in the communication system.

According to the in-vehicle communication system of the present embodiments, an in-vehicle device having a function of detecting an anomaly in an in-vehicle system and an interface device including an anomaly notification unit that notifies an occupant of the vehicle of an anomaly state are connected to each other via a communication path for transmitting an alternating current signal. A high-potential side drive terminal of the anomaly notification unit driven by a direct current signal is connected to a communication line of the communication path via an inductor, and the in-vehicle device notifies the occupant of the vehicle of the anomaly by driving the anomaly notification unit with applying the direct current drive signal to the communication line when detecting the anomaly in the in-vehicle system.

With this configuration, even if an anomaly occurs in the function of communication performed between the in-vehicle device and the interface device, the in-vehicle device can notify the occupant of the vehicle of the anomaly by driving the anomaly notification unit arranged on the interface device side with applying a direct current drive signal to the communication line.

Further, according to the in-vehicle communication system of the present embodiments, the in-vehicle device is provided with a direct current power supply circuit, and the electric power is supplied to the interface device via one of the communication lines to which the high potential side drive terminal is not connected. With this configuration, the electric power can be supplied to the interface device through the communication line of the communication path without connecting the in-vehicle device and the interface device with a separate power line or the like.

Further, according to the in-vehicle communication system of the present embodiments, the in-vehicle device includes a power supply switch that opens and closes between the power supply terminal of the direct current power supply circuit and the communication line that supplies the electric power to the interface device. Therefore, the in-vehicle device can cut off the electric power supplied to the interface device side as needed.

Further, according to the in-vehicle communication system of the present embodiments, the direct current power supply circuit is provided with the first terminal and the second terminal, and the interface device includes an operation switch operated by the occupant of the vehicle to notify the outside of the vehicle via the in-vehicle device. The second terminal and one end of the operation switch are connected via an inductor to a second communication line different from the first communication line to which the first terminal is connected. The in-vehicle device detects an operation state of the operation switch based on the change in the direct current voltage in the second communication line.

That is, when the occupant of the vehicle operates the operation switch on the interface device side, the direct current voltage of the second communication line changes, so that the in-vehicle device can detect the operation state of the operation switch.

### First Embodiment

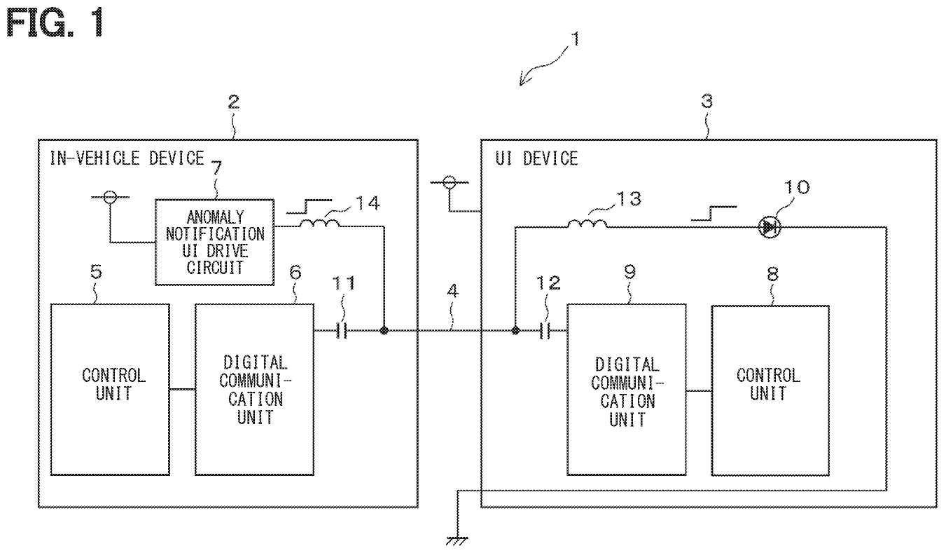

As shown in FIG. 1, an in-vehicle communication system 1 of the present embodiment includes an in-vehicle device 2 and a UI (i.e., user interface) device 3. These devices 2 and 3 are connected to each other via a communication path 4. The in-vehicle device 2 includes a control unit 5, a digital communication unit 6 and an anomaly notification UI drive circuit 7. The UI device 3 includes a control unit 8, a digital communication unit 9, and an LED 10, which is an example of an anomaly notification unit.

The digital communication units 6 and 9 are connected to the communication path 4 via coupling capacitors 11 and 12, respectively. The digital communication protocol includes, for example, Ethernet (registered trademark), INICnet (registered trademark), A²B, and the like, and is used for communications performed by transmitting an alternating current signal. The control unit 5 of the in-vehicle device 2 and the control unit 8 of the UI device 3 communicate with each other via digital communication units 6 and 9, respectively, to transmit and receive information.

The LED 10 of the UI device 3 is arranged to notify an occupant of the vehicle of the occurrence of an anomaly. The “anomaly” here is an anomaly that occurs in an in-vehicle system including the in-vehicle device 2. A cathode, which is a low-potential drive terminal of the LED 10 is connected to the vehicle body ground, and an anode, which is a high-potential drive terminal, is connected to the communication line of the communication path 4 via the inductor 13. The level when the communication line is not driven by the digital communication unit 6 or 9 is the ground level.

The anomaly notification UI drive circuit 7 of the in-vehicle device 2 is arranged to drive the LED 10 to light on. An output terminal of the anomaly notification UI drive circuit 7 is connected to the communication line of the communication path 4 via the inductor 14. When a sensor (not shown) detects that an anomaly has occurred in the in-vehicle system and outputs a detection signal, the anomaly notification UI driving circuit 7 applies a direct current voltage to the communication line to turn on the LED 10 of the UI device 3. Here, the above detection signal may be input to the control unit 5 so that the control unit 5 controls the anomaly notification UI drive circuit 7. The inductors 13 and 14 prevent the influence of the alternating current communication signal transmitted through the communication path 4 from being input to the anomaly notification UI drive circuit 7 and the LED 10, respectively.

As described above, according to the present embodiment, the in-vehicle device 2 having the function of detecting an anomaly in the in-vehicle system, and the interface device 3 including the LED 10 for notifying the occupant of the vehicle of the anomaly state are connected to each other via the communication path 4 for transmitting an alternating current signal. The cathode of the LED 10 is connected to the vehicle body ground, and the anode is connected to the communication line of the communication path 4 via the inductor 13. When the in-vehicle device 2 detects an anomaly in the in-vehicle system, the in-vehicle device 2 notifies the occupant of the vehicle of the anomaly by applying a direct current drive signal to the communication line to drive the LED 10.

With this configuration, even if an anomaly occurs in the function of communication between the in-vehicle device 2 and the interface device 3, the in-vehicle device 2 can notify an occupant of the vehicle of an anomaly by applying the direct current drive signal to the communication line to drive the LED 10 to light on.

### Second Embodiment

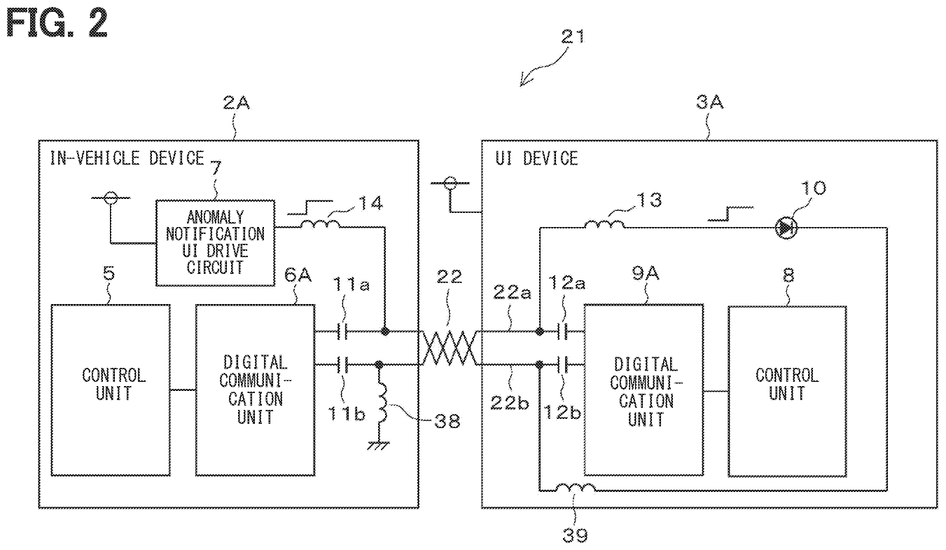

Hereinafter, the identical parts as those in the first embodiment will be designated by the same reference numerals for simplification of the description. Only differences from the first embodiment will be described below. As shown in FIG. 2, in the in-vehicle communication system 21 of the second embodiment, the control unit 5 of the in-vehicle device 2A and the control unit 8 of the UI device 3A communicate to each other via digital communication units 6A and 9A, respectively. The digital communication units 6A and 9A are connected via a two-wire communication path 22. The communication lines 22a and 22b of the communication path 22 are twisted lines, and the communication line 22b is grounded through the inductor 38 on the in-vehicle device 2A side. The cathode of the LED 10 is connected via an inductor 39 to the communication line 22b within the UI device 3A.

### Third Embodiment

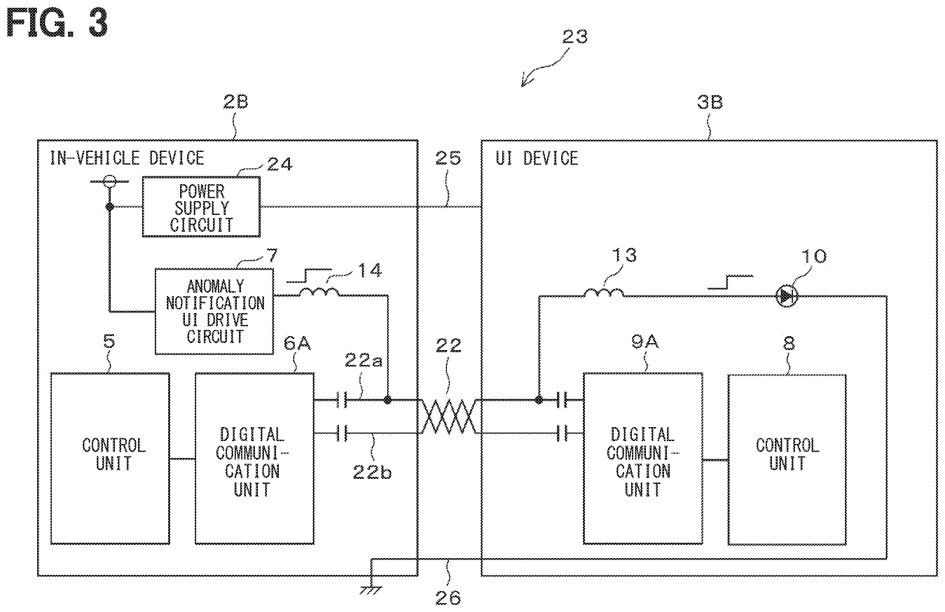

As shown in FIG. 3, in the in-vehicle communication system 23 of the third embodiment, an in-vehicle device 2B and a UI device 3B are connected via a communication path 22. The in-vehicle device 2B has a configuration in which a power supply circuit 24 is added to the in-vehicle device 2A of the second embodiment. The power supply circuit 24 supplies operating electric power to the UI device 3B through the power supply line 25 and the ground line 26. A cathode of the LED 10 of the UI device 3B is connected to the ground line 26.

### Fourth Embodiment

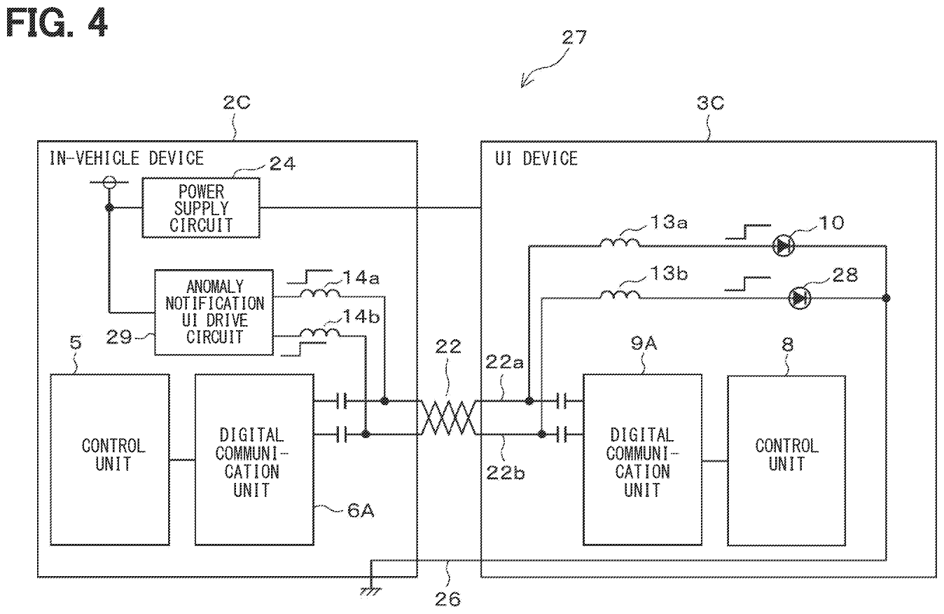

As shown in FIG. 4, in the in-vehicle communication system 23 of the fourth embodiment, an in-vehicle device 2C and a UI device 3C are connected via a communication path 22. The UI device 3C is obtained by adding an LED 28 to the UI device 3B of the third embodiment, and the cathode of the LED 28 is connected to the ground line 26, and the anode is connected to the communication line 22b via the inductor 13b. For example, when the in-vehicle device 2C has a function of reporting to a center device (not shown) by wireless communication, the LED 28 is turned on to notify the occupant of the vehicle that the function of reporting is unavailable due to the anomaly in the function. The emission colors of the LEDs 10 and 28 are different from each other, and are examples of the first notification unit and the second notification unit, respectively.

The in-vehicle device 2C is obtained by replacing the anomaly notification UI drive circuit 7 of the in-vehicle device 2B of the third embodiment with an anomaly notification UI drive circuit 29. The anomaly notification UI drive circuit 29 has an output terminal for driving the LED 28, and the output terminal is connected to the communication line 22b via the inductor 14b. When a sensor (not shown) detects that an anomaly has occurred in the above described notification function and outputs a detection signal, the anomaly notification UI drive circuit 29 applies a direct current voltage to the communication line 22b to turn on the LED 28 of the UI device 3C.

### Fifth Embodiment

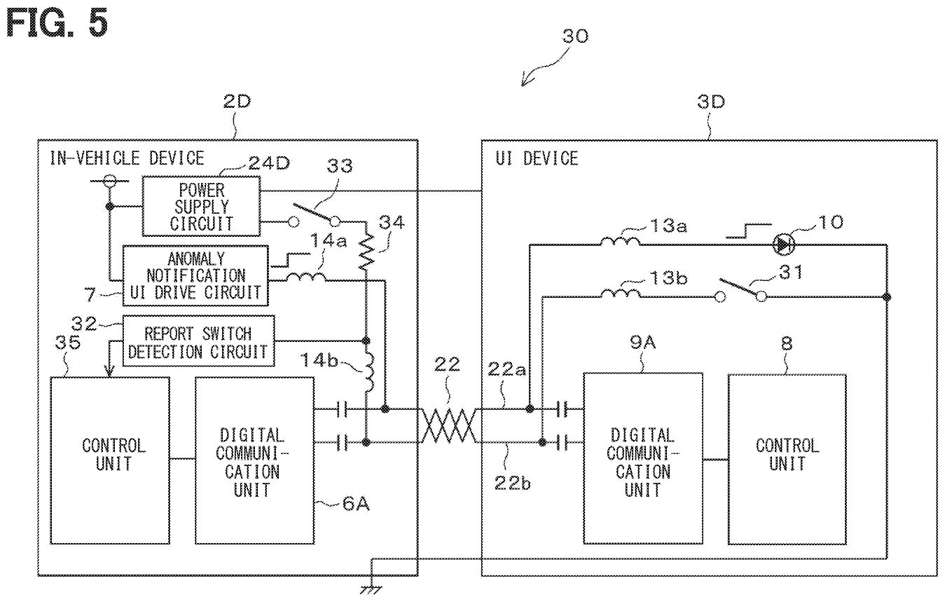

As shown in FIG. 5, in the in-vehicle communication system 30 of the fifth embodiment, an in-vehicle device 2D and a UI device 3D are connected via a communication path 22. The UI device 3D has a configuration in which the LED 28 of the UI device 3C of the fourth embodiment is replaced with a normally open notification switch 31. The in-vehicle device 2D includes a notification switch detection circuit 32 together with the anomaly notification UI drive circuit 7 of the first embodiment.

The power supply circuit 24D has another power supply terminal, which is connected to the communication line 22b through a series circuit of the switch 33, the resistance element 34 and the inductor 14b. A common connection point of the resistance element 34 and the inductor 14b is connected to an input terminal of the notification switch detection circuit 32. An output terminal of the notification switch detection circuit 32 is connected to an input terminal of a control unit 35 instead of the control unit 5. The control unit 35 controls an on and off state of the switch 33.

Next, operation of the fifth embodiment will be described. When the occupant of the vehicle voluntarily determines that it is necessary to notify the center device, the occupant turns on the notification switch 31 of the UI device 3D. The control unit 35 of the in-vehicle device 2D intermittently turns on the switch 33 and refers to the output signal of the notification switch detection circuit 32 in order to detect that the notification switch 31 has been turned on.

If the notification switch 31 is in the off state while the switch 33 is in the on state, the output signal of the detection circuit 32 is high level, and if the notification switch 31 is in the on state, the output signal of the detection circuit 32 is changed to the low level. When the control unit 35 detects that the output signal has changed to a low level, the control unit 35 starts wireless communication and notifies the center device. [0029] (Sixth Embodiment).

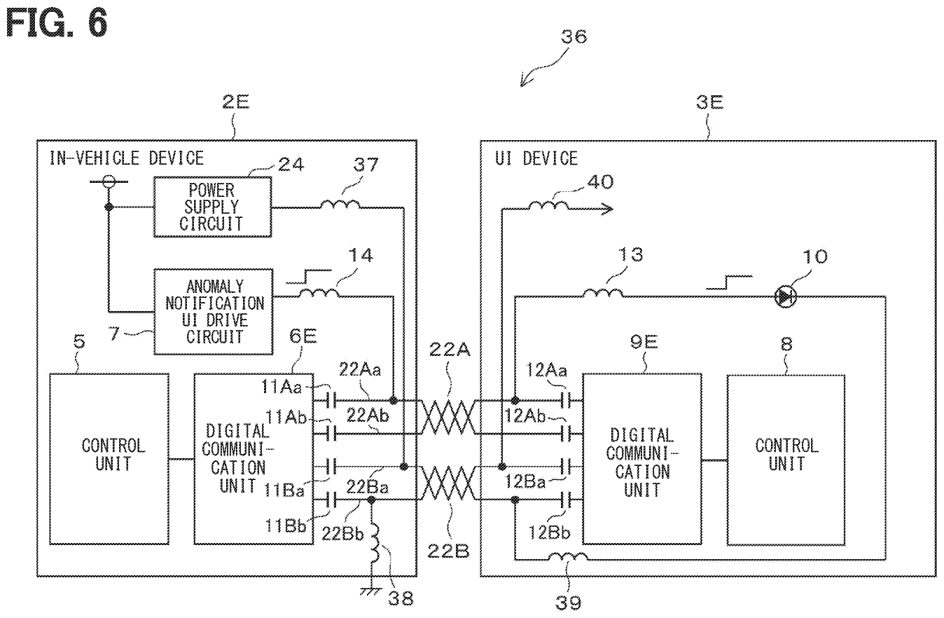

As shown in FIG. 6, in an in-vehicle communication system 36 of the sixth embodiment, a digital communication unit 6E of an in-vehicle device 2E and a digital communication unit 9E of a UI device 3E are connected via two sets of communication paths 22A and 22B. A ring type communication path is provided by these two sets of communication paths 22A and 22B. The connection state on the communication path 22A side is the same as in the third embodiment. A power supply terminal of the power supply circuit 24 is connected via an inductor 37 to the communication line 22Ba of the communication path 22B. The communication line 22Bb is connected through an inductor 38 to the body ground. That is, the power supply circuit 24 supplies power to the UI device 3E via the communication path 22B.

In the UI device 3E, the cathode of the LED 10 is connected via the inductor 39 to the communication line 22Bb. The electric power is supplied to the internal circuit of the UI device 3E through an inductor 40 connected to the communication line 22Bb.

### Seventh Embodiment

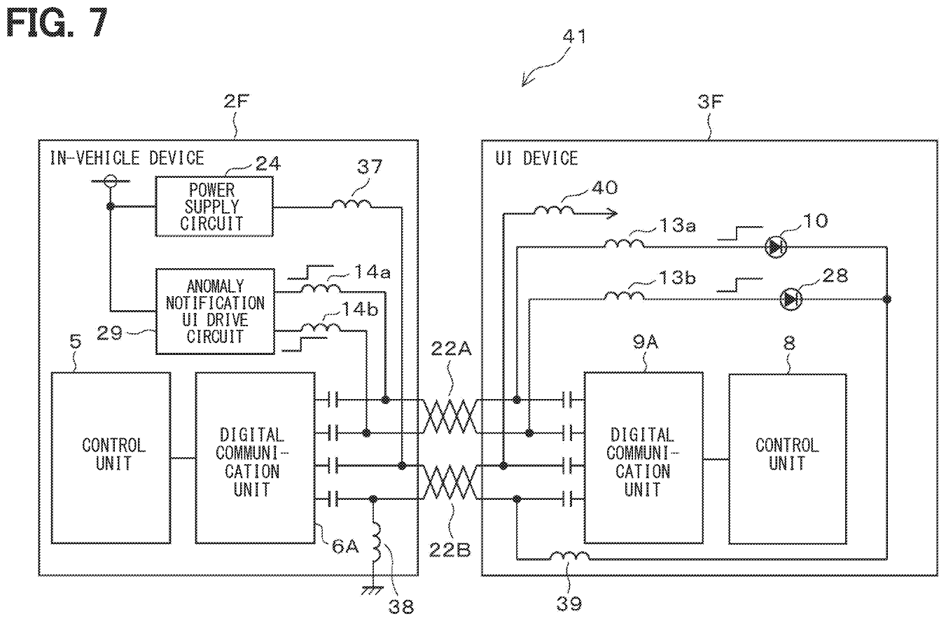

As shown in FIG. 7, an in-vehicle communication system 41 of the seventh embodiment is obtained by combining the configuration of the sixth embodiment with the configuration of the fourth embodiment. The in-vehicle device 2F has an anomaly notification UI drive circuit 29 in place of the anomaly notification UI drive circuit 7, and the UI device 3F has an LED 28. The connection state on the communication path 22A side is the same as in the fourth embodiment.

### Eighth Embodiment

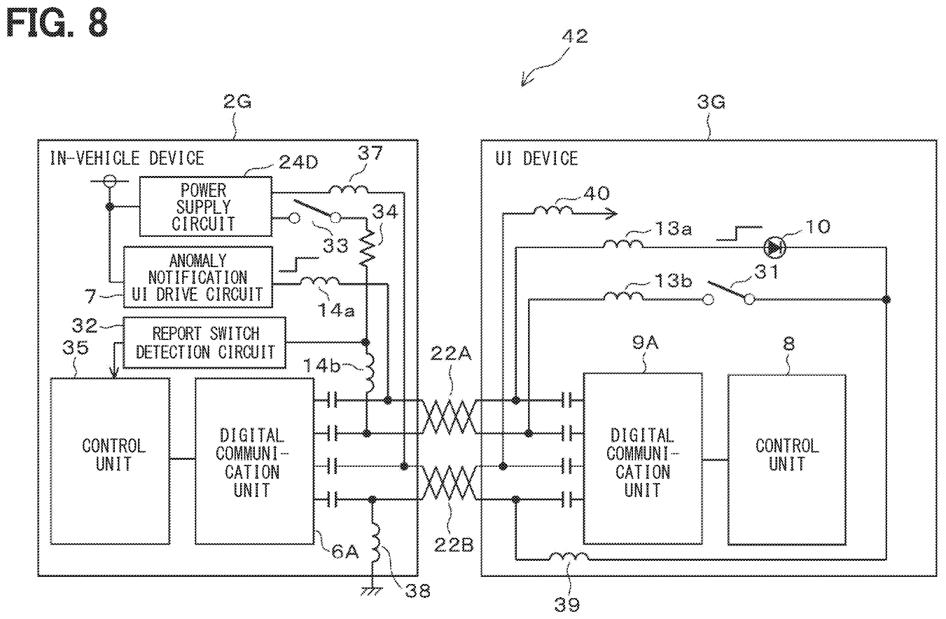

As shown in FIG. 8, an in-vehicle communication system 42 of the eighth embodiment is obtained by combining the configuration of the sixth embodiment with the configuration of the fifth embodiment. The UI device 3G has a notification switch 31, and the in-vehicle device 2G has an anomaly notification UI drive circuit 7 and a notification switch detection circuit 32. The connection state on the communication path 22A side is the same as in the fifth embodiment.

### Ninth Embodiment

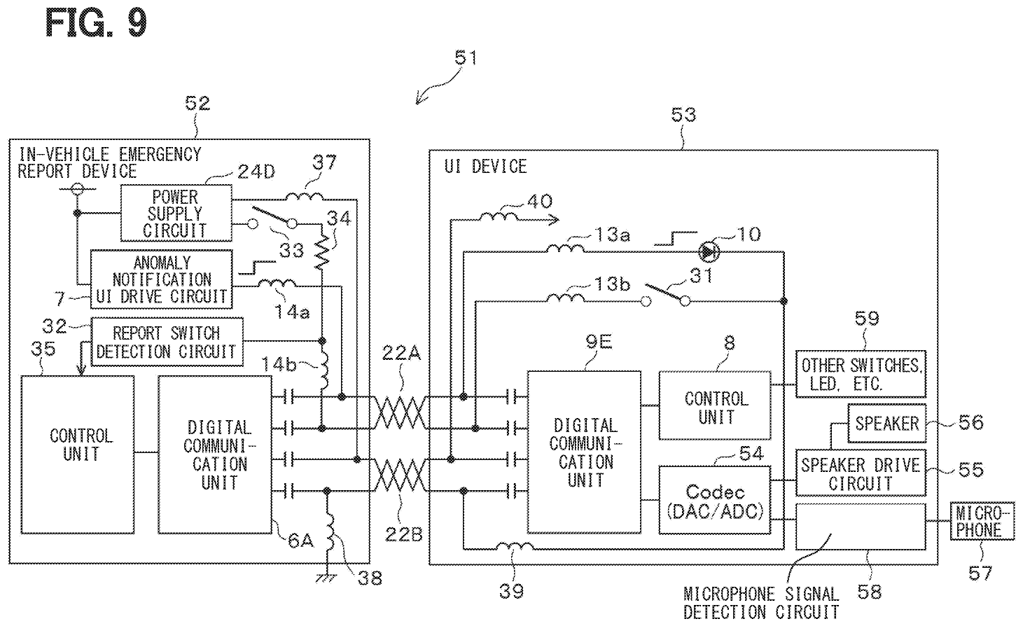

As shown in FIG. 9, an in-vehicle communication system 51 of the ninth embodiment is obtained by configuring the in-vehicle device 2G of the eighth embodiment as an in-vehicle emergency notification device 52, and the UI device is an UI device 53 provided with an interface for voice notification corresponding to the in-vehicle emergency notification device 52. The UI device 53 is designed based on the UI device 3G of the eighth embodiment, and the codec 54 is connected to the digital communication unit 9E. The codec 54 includes a D/A converter and an A/D converter.

A speaker 56 is connected to the codec 54 via a speaker drive circuit 55. An audio signal input to a microphone 57 is also input to the codec 54 via a microphone signal detection circuit 58. Other switches and LEDs 59 arranged in the UI device 53 are connected to the control unit 8, and operation signals of the switches are input. Further, the control unit 8 drives the LED to light up. The UI device 53 is arranged above the windshield of the vehicle as an overhead console (i.e., OHC), for example.

For example, when a vehicle crashes, the in-vehicle emergency notification device 52 connects a wireless communication line to the center device to execute an emergency notification, so that the occupant of the vehicle makes a phone call with an operator of the center device via the UI device 53 by voice. At this time, voice signals are transmitted as digital signals between the UI device 53 and the in-vehicle emergency notification device 52 by the digital communication units 9E and 6E.

### Tenth Embodiment

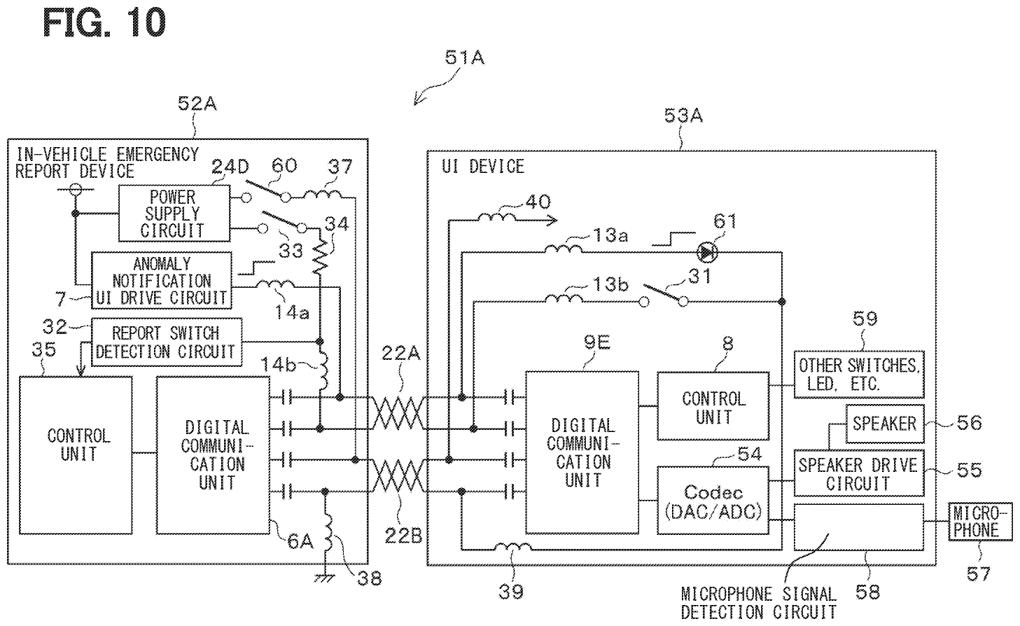

As shown in FIG. 10, the in-vehicle communication system 51A of the tenth embodiment is obtained by replacing the in-vehicle emergency notification device 52 of the ninth embodiment with an in-vehicle emergency notification device 52A in which the switch 60 is arranged between the power supply terminal of the power supply circuit 24D and the inductor 37. Also, the UI device 53A has a configuration in which the LED 10 of the UI device 53 is replaced with an LED 61. The LED 61 is lit on to notify the occupant of the vehicle that the in-vehicle emergency notification device 52A is executing an emergency notification to the center device.

After executing an emergency notification to the center device, the in-vehicle emergency notification device 52A waits for an incoming call from the center device side without making a voice call, or cuts off the power supply to the UI device 53A by turning off the switch 60 while waiting for the turn-on operation of the emergency notification switch 31 again by the occupant of the vehicle. In this way, in a state where power consumption is reduced, the in-vehicle emergency notification device 52A can turn on the LED 61 of the UI device 53A and detect the turn-on operation of the notification switch 31. When the control unit 35 detects that the emergency notification switch 31 has been turned on by the occupant of the vehicle via the detection circuit 32, the control unit 35 turns on the switch 60 to resume power supply to the UI device 53A.

In the event of an accident, when recognizing a situation that the in-vehicle emergency notification device 52A is in an unavailable state for executing an emergency notification to the center device, by intermittently lighting the LED 61 at a cycle of 0.5 S, for example, to notify the occupant of the vehicle that there is an anomaly in the emergency notification system.

### OTHER EMBODIMENTS

The communication method may not be limited to Ethernet, INICnet, or A²B, and may be communication performed by transmitting an alternating current signal.

The anomaly notification unit may not be limited to the LED 10, and may be any other lighting device or any device that has a notification function by sound or voice, such as a buzzer, and is driven by a direct current voltage.

Although the disclosure has been described in accordance with the examples, it is understood that the present disclosure is not limited to the above examples or structures. The present disclosure incorporates various modifications and variations within the scope of equivalents. Furthermore, various combination and formation, and other combination and formation including one, more than one or less than one element may be made within the spirit and scope of the present disclosure.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

What is claimed is:

1. An in-vehicle communication system comprising:
an in-vehicle device having a function of detecting an anomaly in an in-vehicle system;
an interface device having an user interface function including an anomaly notification unit for notifying an occupant of a vehicle of an anomaly state; and
a communication path connecting between the in-vehicle device and the interface device, wherein:
the in-vehicle communication system executes one or both of information transmission and information reception by transmitting an alternating current signal through the communication path between the in-vehicle device and the interface device;
the anomaly notification unit is driven by a direct current signal, and has a high potential drive terminal connected to a communication line of the communication path via an inductor; and
the in-vehicle device notifies the occupant of the vehicle of the anomaly state by applying a direct current drive signal to the communication line to drive the anomaly notification unit when detecting the anomaly state of the in-vehicle system.

2. The in-vehicle communication system according to claim 1, wherein:
the anomaly notification unit has a low potential drive terminal connected to a body ground of the vehicle.

3. The in-vehicle communication system according to claim 1, wherein:
a low potential drive terminal of the anomaly notification unit is connected to a communication line which is connected to ground in the communication path.

4. The in-vehicle communication system according to claim 1, wherein:
the in-vehicle device includes a direct current power supply circuit, and supplies an electric power to the interface device through a power supply line and a ground line; and
the anomaly notification unit has a low potential drive terminal connected to the ground line.

5. The in-vehicle communication system according to claim 1, wherein:
communication is executed by a method using two or more communication lines capable of superimposing a direct current voltage in the communication path;
the in-vehicle device includes a direct current power supply circuit; and
electric power of the direct current power supply circuit is supplied to the interface device via one of the communication lines to which the high potential drive terminal is not connected.

6. The in-vehicle communication system according to claim 5, wherein:
the in-vehicle device includes a power supply switch that opens and closes between a power supply terminal of a direct current power supply circuit and a communication line that supplies electric power to the interface device.

7. The in-vehicle communication system according to claim 5, wherein:
the direct current power supply circuit has a power supply terminal defined as a first terminal and a second terminal which is another power supply terminal;
the interface device includes an operation switch operated by an occupant of the vehicle for reporting to an outside of the vehicle via the in-vehicle device;
the second terminal and one end of the operation switch are connected via an inductor to a second communication line different from a first communication line to which the first terminal is connected; and
the in-vehicle device detects an operation state of the operation switch based on a change in a direct current voltage of the second communication line.

8. The in-vehicle communication system according to claim 1, wherein:
the anomaly notification unit is an LED for notifying an occupant of the vehicle that the in-vehicle device has an anomaly in an emergency notification system for an outside of the vehicle; and
a signal transmitted from the in-vehicle device is a drive signal for the LED.

9. The in-vehicle communication system according to claim 1, wherein:
communication is executed by a method using two or more communication lines capable of superimposing a direct current voltage in the communication path;
the anomaly notification unit is defined as a first notification unit;
the interface device includes a second notification unit that notifies an occupant of the vehicle of a state of the vehicle different from the first notification unit; and
a high potential drive terminal of the second notification unit is connected via an inductor to a communication line different from a communication line to which the high potential drive terminal of the anomaly notification unit is connected.

10. An in-vehicle device defined in the in-vehicle communication system according to claim 1.

11. An interface device defined in the in-vehicle communication system according to claim 1.
